(19) United States
(12) Patent Application Publication
(10) Pub. No.: US 2014/0136114 A1
(43) Pub. Date: May 15, 2014

(54) Apparatus and Method for Formation Resistivity Measurements

(71) Applicant: GREATWALL DRILLING COMPANY, Beijing (CN)

(72) Inventors: Naizheng Liu, Beijing (CN); Qihui Zhao, Beijing (CN); Yuzhou Lu, Beijing (CN); Rui Bai, Beijing (CN); Jing Li, Houston, TX (US); Ce Liu, Sugar Land, TX (US); Yonghe Li, Beijing (CN)

(73) Assignee: Greatwall Drilling Company, Beijing (CN)

(21) Appl. No.: 13/672,951

(22) Filed: Nov. 9, 2012

(51) Int. Cl. G01V 3/10; G06F 15/00

(52) U.S. Cl. CPC G01V 3/10; G06F 15/00
USPC 702/7

(57) ABSTRACT

An apparatus for measuring formation resistivity in logging while drilling application includes a tool body, a pair of receivers deployed on the tool body including a first receiver and a second receiver, a measuring transmitter deployed on the tool body and at an axial distance from the pair of receivers, and a compensating transmitter deployed on the tool body and positioned substantially at the midpoint of the pair of receivers. The compensating transmitter transmits compensating signals to the pair of receivers and the measuring transmitter transmits measuring signals to the pair of receivers. The pair of receivers measures the amplitudes and phases of the compensating signals and the measuring signals in a sequential order and computes a compensated amplitude ratio and a compensated differential phase accordingly. A corresponding method for measuring formation resistivity is also provided.

### FIELD OF THE INVENTION

The present invention relates generally to the field of electrical resistivity well logging. More particularly, the invention relates to an apparatus and a method for making measurements of resistivity of a subterranean formation adjacent the wellbore.

### BACKGROUND OF THE INVENTION

The use of electrical measurements for gathering of downhole information, such as logging while drilling (“LWD”), measurement while drilling (“MWD”), and wireline logging system, is well known in the oil industry. Such technology has been utilized to obtain earth formation resistivity (or conductivity; the terms “resistivity” and “conductivity”, though reciprocal, are often used interchangeably in the art.) and various rock physics models (e.g. Archie's Law) can be applied to determine the petrophysical properties of a subterranean formation and the fluids therein accordingly. As known in the prior art, resistivity is an important parameter in delineating hydrocarbon (such as crude oil or gas) and water contents in the porous formation. It is preferable to keep the borehole in the pay zone (the formation with hydrocarbons) as much as possible so as to maximize the recovery.

However, the formation resistivity measurements suffer disturbance from the temperature drift of measuring circuitry and antennas and irregularity of the surface of the borehole. To eliminate error factors as mentioned above and improve the accuracy of measurements, several systems and methods have been developed for making formation resistivity measurements as follows.

FIG. 1 illustrates a prior art of a well logging device (also known as an electromagnetic propagation logging device). The propagation logging device 100 includes a transmitter T1 and at least two receivers R1 and R2 mounted on a tool body 102 and the transmitter T1 is at an axial distance from the two receivers R1 and R2. When transmitter T1 is energized, it transmits electromagnetic signals into formation near the borehole. The electromagnetic signals then propagate through formation and are measured by the receivers R1 and R2. The phase difference and amplitude ratio of electromagnetic signals reflected on the receivers R1 and R2 can be determined and the surrounding formation resistivity then can be computed accordingly (“Phase difference” or “phase shift” between two receivers R1 and R2 may be used interchangeably with “differential phase” between two receivers R1 and R2 in the art; The “amplitude attenuation” is usually defined as a logarithmic function of the amplitude ratio and has a unit in dB. The “amplitude ratio” does not have a unit. Both terms of “amplitude attenuation” and “amplitude ratio” can be used to describe the decay of signals propagating from one receiver to another). Also, the error factors induced by the transmitter T1 can be cancelled or reduced during computation of differential phase and amplitude ratio.

FIG. 2 illustrates a prior art of a “borehole compensation technique.” A compensated device 200 includes a tool string 202 and a pad 204, which is deployed with a pair of transmitters T1 and T2 and a pair of receivers R1 and R2. The pad 204 is positioned against the side of a borehole 206, which may be filled with mud or fluid.

To make resistivity measurements, the two transmitters T1 and T2 transmit electromagnetic signals in a sequential order and the receivers R1 and R2 receive and measure the electromagnetic signals from the transmitters T1 and T2. In frequency domain, the measured electromagnetic signals at the receivers R1 and R2 after one cycle of measurements can be expressed as follows.

Ã_{R1}^{T1}=A_{R1}^{T1}·e^{jφ}^{_{R1}}^{^{T1}}=c_{T1}^{err}·c_{R1(T1)}^{err}·a_{R1}^{T1}·e^{j(φ}^{_{R1}}^{^{T1}}^{+φ}^{_{R1(T1)}}^{^{err}}^{+φ}^{_{T1}}^{^{err}}⁾ (1)

Ã_{R2}^{T1}=A_{R2}^{T1}·e^{jφ}^{_{R2}}^{^{T1}}=c_{T1}^{err}·c_{R2(T1)}^{err}·a_{R2}^{T1}·e^{j(φ}^{_{R2}}^{^{T1}}^{+φ}^{_{R2(T1)}}^{^{err}}^{+φ}^{_{T1}}^{^{err}}⁾ (2)

Ã_{R1}^{T2}=A_{R1}^{T2}·e^{jφ}^{_{R2}}^{^{T2}}=c_{T2}^{err}·c_{R2(T2)}^{err}·a_{R2}^{T2}·e^{j(φ}^{_{R2}}^{^{T2}}^{+φ}^{_{R2(T2)}}^{^{err}}^{+φ}^{_{T2}}^{^{err}}⁾ (3)

Ã_{R2}^{T2}=A_{R2}^{T2}·e^{jφ}^{_{R2}}^{^{T2}}=c_{T2}^{err}·c_{R2(T2)}^{err}·a_{R2}^{T2}·e^{j(φ}^{_{R2}}^{^{T2}}^{+φ}^{_{R2(T2)}}^{^{err}}^{+φ}^{_{T2}}^{^{err}}⁾ (4)

where Ã_{R1}^{T1}, Ã_{R2}^{T1}, Ã_{R1}^{T2}, and Ã_{R2}^{T2} are the measured electromagnetic signals at the receivers R1 and R2 in complex format, the superscripts and subscripts of Equations (1-4) represent the transmitters T1 or T2 and receivers R1 or R2 that are active when the signals are being measured; the complex quantities Ã_{R1}^{T1}, Ã_{R2}^{T1}, Ã_{R1}^{T2}, and Ã_{R2}^{T2} are composed of measured amplitudes A_{R1}^{T1}, A_{R2}^{T1}, A_{R1}^{T2}, A_{R2}^{T2} and measured phases φ_{R1}^{T1}, φ_{R2}^{T1}, φ_{R1}^{T2}, φ_{R2}^{T2} correspondingly; where a_{R1}^{T1}, a_{R2}^{T1}, a_{R1}^{T2}, a_{R2}^{T2} and φ_{R1}^{T1}, φ_{R2}^{T1}, φ_{R1}^{T2}, φ_{R2}^{T2} are the formation related amplitude components and phase components in the measured electromagnetic signals at the receivers R1 and R2 when the transmitters T1 and T2 fire respectively; c_{T1}^{err}, c_{T2}^{err}, φ_{T1}^{err} and φ_{T2}^{err} are the transmitter induced errors in signal amplitude and phase respectively on the pair of receivers R1 and R2 when the transmitters T1 and T2 fire; c_{R1(T1)}^{err}, c_{R2(T1)}^{err}, φ_{R1(T1)}^{err} and φ_{R2(T1)}^{err} represent the receiver induced errors in signal amplitude and phase respectively in the pair of receivers R1 and R2 when the transmitter T1 fires; c_{R1(T2)}^{err}, c_{R2(T2)}^{err}, φ_{R1(T2)}^{err} and φ_{R2(T2)}^{err} are the receiver induced errors in signal amplitude and phase respectively in the pair of receivers R1 and R2 when the transmitter T2 fires.

Due to the symmetrical arrangement of the pair of transmitters T1 and T2 and the pair of receivers R1 and R2, both the receiver induced errors and the transmitter induced errors, which may be caused by embedded antennas or corresponding circuits, can be cancelled out from the measured amplitudes and measured phases. Accordingly, the results of compensated measurements between electromagnetic signal amplitudes and phases on the receivers R1 and R2 for formation resistivity and dielectric constant computation can become more accurate because only the formation related amplitude and phase components would be left in the compensated amplitude ratios and compensated differential phases. Corresponding mathematical algorithm can be shown in Equations (1-7) below.

To make compensated measurements between electromagnetic signal amplitudes and phases reflected on the receivers R1 and R2 for computing formation resistivity and dielectric constant, the first step is to derive the complex ratios of the measured electromagnetic signals at the receiver R1 to the measured electromagnetic signals at the receiver R2 when the transmitters T1 and T2 fire respectively as follows.

$$\begin{matrix}{\tilde{ρ}}_{T 1} = \frac{{\tilde{A}}_{R 2}^{T 1}}{{\tilde{A}}_{R 1}^{T 1}} = \frac{{A}_{R 2}^{T 1} \cdot {e}^{{jφ}_{R 2}^{T 1}}}{{A}_{R 1}^{T 1} \cdot {e}^{{jφ}_{R 1}^{T 1}}} = \frac{{c}_{R 2 ( T 1 )}^{err}}{{c}_{R 1 ( T 1 )}^{err}} \cdot \frac{{a}_{R 2}^{T 1}}{{a}_{R 1}^{T 1}} \cdot {e}^{j ( {ϕ}_{R 2}^{T 1} - {ϕ}_{R 1}^{T 1} + {ϕ}_{R 2 ( T 1 )}^{err} - {ϕ}_{R 1 ( T 1 )}^{err} )} & ( 5 ) \\ {\tilde{ρ}}_{T 2} = \frac{{\tilde{A}}_{R 1}^{T 2}}{{\tilde{A}}_{R 2}^{T 2}} = \frac{{A}_{R 1}^{T 2} \cdot {e}^{{jφ}_{R 1}^{T 2}}}{{A}_{R 2}^{T 2} \cdot {e}^{{jφ}_{R 2}^{T 2}}} = \frac{{c}_{R 1 ( T 2 )}^{err}}{{c}_{R 2 ( T 2 )}^{err}} \cdot \frac{{a}_{R 1}^{T 2}}{{a}_{R 2}^{T 2}} \cdot {e}^{j ( {ϕ}_{R 1}^{T 2} - {ϕ}_{R 2}^{T 2} + {ϕ}_{R 1 ( T 2 )}^{err} - {ϕ}_{R 2 ( T 2 )}^{err} )} & ( 6 )\end{matrix}$$

After taking the complex ratio of the measured electromagnetic signals at the pair of receivers R1 and R2 at each transmitter firing, the transmitter induced errors in signal amplitude and phase (c_{T1}^{err}, c_{T2}^{err}, φ_{T1}^{err} and φ_{T2}^{err}) are cancelled in Equations (5-6).

The second step is to take multiplication of \tilde{ρ}_{T1} and \tilde{ρ}_{T2} from Equations (5) and (6) as follows.

$${\tilde{ρ}}_{c} = {\tilde{ρ}}_{T 1} \cdot {\tilde{ρ}}_{T 2} = \frac{{\tilde{A}}_{R 2}^{T 1}}{{\tilde{A}}_{R 1}^{T 1}} \cdot \frac{{\tilde{A}}_{R 1}^{T 2}}{{\tilde{A}}_{R 2}^{T 2}} = \frac{{A}_{R 2}^{T 1} \cdot {e}^{{jφ}_{R 2}^{T 1}}}{{A}_{R 1}^{T 1} \cdot {e}^{{jφ}_{R 1}^{T 1}}} \cdot \frac{{A}_{R 1}^{T 2} \cdot {e}^{{jφ}_{R 1}^{T 2}}}{{A}_{R 2}^{T 2} \cdot {e}^{{jφ}_{R 2}^{T 2}}} = \frac{{a}_{R 2}^{T 1}}{{a}_{R 1}^{T 1}} \cdot \frac{{a}_{R 1}^{T 2}}{{a}_{R 2}^{T 2}} \cdot {e}^{j [ ( {ϕ}_{R 2}^{T 1} - {ϕ}_{R 1}^{T 1} ) + ( {ϕ}_{R 1}^{T 2} - {ϕ}_{R 2}^{T 2} ) ]} \qquad ( 7 )$$

After taking multiplication of \tilde{ρ}_{T1} and \tilde{ρ}_{T2}, the receiver induced errors in amplitude and phase are cancelled too, based on the arrangement of symmetrical transmitters T1 and T2 and the receiver property consistency during the time period between the firing of transmitter T1 and the firing of transmitter T2 in a measurement cycle (c_{R1(T1)}^{err}=c_{R1(T2)}^{err}, c_{R2(T1)}^{err}=c_{R2(T2)}^{err}, φ_{R1(T1)}^{err}=φ_{R1(T2)}^{err}, and φ_{R1(T1)}^{err}=φ_{R2(T2)}^{err}). In Equation (7), only the formation related signal amplitude ratio and phase difference are left. The compensated complex ratio \tilde{ρ}_{c} derived out from the measurements by a pair of transmitters and a pair of receivers can automatically eliminate transmitter induced errors and receiver induced errors in the compensated amplitude ratio and compensated differential phase.

The magnitude of the compensated complex ratio \tilde{ρ}_{c} represents a compensated amplitude ratio of the measured electromagnetic signals at the pair of receivers R1 and R2. The phase of the compensated complex ratio \tilde{ρ}_{c} represents a compensated differential phase of the measured electromagnetic signals at the pair of receivers R1 and R2. Both of them can be derived out from measured signals as follows.

$$\begin{matrix}{ρ}_{c} = \vert \tilde{ρ} \vert = \frac{{A}_{R 2}^{T 1}}{{A}_{R 1}^{T 1}} \cdot \frac{{A}_{R 1}^{T 2}}{{A}_{R 2}^{T 2}} & ( 8 ) \\ {Δφ}_{c} = arg ( \tilde{ρ} ) = ( {φ}_{R 2}^{T 1} - {φ}_{R 1}^{T 1} ) + ( {φ}_{R 1}^{T 2} - {φ}_{R 2}^{T 2} ) & ( 9 )\end{matrix}$$

Alternatively, the compensated amplitude ratio and the compensated differential phase in Equations (8-9) can be scaled down to the range of uncompensated measurements (single transmitter measurements) by taking square roots of the compensated complex ratios as shown below. The benefits to scale down the compensated amplitude ratio and the compensated differential phase to the range of uncompensated measurements are that users still can use the conversion chart (converting the amplitude ratio and differential phase to formation dielectric constant and resistivity) of uncompensated measurements to compute the formation dielectric constant and resistivity according to the scaled down compensated amplitude ratio and differential phase.

$$\begin{matrix}{\tilde{ρ}}_{c}^{′} = \sqrt{\frac{{\tilde{A}}_{R 2}^{T 1}}{{\tilde{A}}_{R 1}^{T 1}} \cdot \frac{{\tilde{A}}_{R 1}^{T 2}}{{\tilde{A}}_{R 2}^{T 2}}} & ( 10 ) \\ {\tilde{ρ}}_{c}^{′} = \vert \tilde{ρ} \vert \sqrt{\frac{{A}_{R 2}^{T 1}}{{A}_{R 1}^{T 1}} \cdot \frac{{A}_{R 1}^{T 2}}{{A}_{R 2}^{T 2}}} & ( 11 ) \\ {Δφ}_{c}^{′} = \frac{( {φ}_{R 2}^{T 1} - {φ}_{R 1}^{T 1} ) + ( {φ}_{R 1}^{T 2} - {φ}_{R 2}^{T 2} )}{2} & ( 12 )\end{matrix}$$

where \tilde{ρ}_{c}′ has a magnitude equivalent to an uncompensated complex ratio; where compensated ratio ρ_{c}′ and differential phase Δφ_{c}′ are in the same magnitude order with an uncompensated ratio and uncompensated differential phase (herein uncompensated amplitude ratio and uncompensated differential phase mean the amplitude ratio and differential phase measured by a single transmitter firing), respectively.

The definitions of the compensated ratio and phase expressed by Equation (8) and (9) are mathematically equivalent to the definitions in Equations (11) and (12). Either of the two definitions can be applied as long as the definitions used in calculating the compensated amplitude ratio and compensated differential phase from tool measurements must be consistent with the ones used in creating the conversion chart.

However, based on results of the mathematical deduction through Equations (1-7), only the formation related amplitude and phase components would be left in the compensated amplitude ratios and compensated differential phases as stated in Equations (11-12). Therefore, the derived compensated amplitude ratio and compensated differential phase theoretically only represent the formation related amplitude ratio and differential phase as shown below.

$$\begin{matrix}{ρ}_{c}^{′} = \vert {\tilde{ρ}}_{c}^{′} \vert = \sqrt{\frac{{a}_{R 2}^{T 1}}{{a}_{R 1}^{T 1}} \cdot \frac{{a}_{R 1}^{T 2}}{{a}_{R 2}^{T 2}}} & ( 13 ) \\ {Δφ}_{c}^{′} = \frac{( {φ}_{R 2}^{T 1} - {φ}_{R 1}^{T 1} ) + ( {φ}_{R 1}^{T 2} - {φ}_{R 2}^{T 2} )}{2} & ( 14 )\end{matrix}$$

Compared to the prior art shown in FIG. 1, the borehole compensation technique disclosed in FIG. 2 not only can cancel the transmitter induced errors in signal amplitude and phase, but also can cancel the receiver induced errors in signal amplitude and phase by the arrangement of symmetrical transmitters.

FIGS. 3-5 show other prior arts of resistivity tools employing compensation mechanism. In FIG. 3, similar to the compensated device 200 shown in FIG. 2, the tool body 102 is a section of drill string and it is deployed with a pair of receivers R1 and R2 and a pair of transmitters T1 and T2. The pair of receivers R1 and R2 is located between the pair of transmitters T1 and T2, which are disposed symmetrically with respect to the midpoint of the pair of receivers R1 and R2 (the distance from the midpoint of the pair of receivers R1 and R2 to the transmitters T1 and T2 are both equal to L). In FIGS. 4 and 5, applications with different numbers of pairs of transmitters T1 and T2 and receivers are disclosed. Multiple transmitter-receiver offsets can help multiple depth formation investigation. Also, the larger the transmitter-receiver offset is, the greater the depth of formation investigation could be achieved.

However, the need of a pair of transmitters positioned on two sides of a pair of receivers would increase the length of a measurement tool significantly, especially for the measurement tool for multiple depth investigation, where multiple pairs of transmitters are required. Furthermore, the longer the length of the measurement tool is, the more side effects would be caused. Also, increasing the length of the measurement tool would also increase its manufacturing cost.

FIG. 6 shows another prior art of resistivity tool utilizing a pair of calibrating transmitters T1 and T2 to solve the problem of lengthy tool body due to the need of a pair of transmitters for each depth investigation. In FIG. 6, the tool body 102 is deployed with a pair of calibrating transmitters T1 and T2, an unpaired transmitter T3, and a pair of receivers R1 and R2. The pair of receivers R1 and R2 is located between the pair of calibrating transmitters T1 and T2, which are disposed symmetrically with respect to the midpoint of the pair of receivers R1 and R2 (the distance from the midpoint of the pair of receivers R1 and R2 to the transmitters T1 and T2 are both equal to L1). The unpaired transmitter T3 has a different spacing from the midpoint of the pair of receivers R1 and R2 for obtaining a different depth of investigation from the depth of investigation obtained by the pair of calibrating transmitters T1 and T2.

When fire the pair of calibrating transmitter T1 and T2 sequentially, the measured differential phases in a measurement cycle can be denoted as follows.

Δφₘₑₐₛ^{TX1}=Δφ^{TX1}+Δφ_{RX}^{err} (15)

Δφₘₑₐₛ^{TX2}=Δφ^{TX2}−Δφ_{RX}^{err} (16)

where Δφₘₑₐₛ^{TX1} and Δφₘₑₐₛ^{TX2} are measured differential phases when the pair of calibrating transmitters T1 and T2 fire respectively; Δφ^{TX1} and Δφ^{TX2} are phase shifts related to the formation properties; Δφ_{RX}^{err} is the receiver-induced error in phase.

Under the condition that the pair of calibrating transmitters T1 and T2 is symmetrically deployed with respect to the midpoint of the pair of receivers R1 and R2, both Δφ^{TX1} and Δφ^{TX2} would be equal to Δφ. The receiver-induced error in phase Δφ_{RX}^{err} and the formation related phase shift Δφ can be solved from Equations (15-16) as follows.

$$\begin{matrix}{Δφ}_{RX}^{err} = \frac{{Δφ}_{meas}^{TX 1} - {Δφ}_{meas}^{TX 2}}{2} & ( 17 ) \\ Δφ = \frac{{Δφ}_{meas}^{TX 1} + {Δφ}_{meas}^{TX 2}}{2} & ( 18 )\end{matrix}$$

The solved receiver-induced error in phase Δφ_{RX}^{err} can be used to calibrate the measurements by the unpaired transmitter T3. In case more unpaired transmitters are used, the induced errors by each of the unpaired transmitter all can be calibrated by the pair of calibrating transmitters T1 and T2 in the same way.

FIG. 7 shows a further prior art of resistivity tool utilizing a pair of calibrating transmitters Tc1 and Tc2 which is located between a pair of receivers R1 and R2 to solve the problem of lengthy tool body. Same as the prior art disclosed in FIG. 6, the pair of calibrating transmitters Tc1 and Tc2 can calibrate the receiver-induced errors when measuring transmitters s T1 and T2 fire respectively. The length of the tool body 102 in FIG. 7 can even be shorter than the length of the tool body 102 in FIG. 6 because the pair of calibrating transmitters Tc1 and Tc2 is located between the pair of receivers R1 and R2. However, when the calibrating transmitters Tc1 and Tc2 are too close to the pair of receivers R1 and R2, the strong coupling between the transmitter antenna and receiver antenna may bring the risk to the accuracy in electromagnetic wave attenuation and phase shift measurement reflected in the pair of receivers R1 and R2.

As described above, a need exists for an improved apparatus and method for measurements of formation resistivity.

A further need exists for an improved apparatus and method for measurements of formation resistivity utilizing a measurement tool without a prolonged length to reduce side effects and manufacturing costs.

A further need exists for an improved apparatus and method for measurements of formation resistivity utilizing a measurement tool with a compensating transmitter to eliminate or reduce transmitter and receiver induced errors in signal amplitude and phase for better measurement accuracy.

A further need exists for an improved apparatus and method for measurements of formation resistivity utilizing a measurement tool with a compensating transmitter to calibrate receiver-induced errors in amplitude and phase without any interference due to a short distance between the compensating transmitters and a pair of receivers.

The present embodiments of the apparatus and the method meet these needs and improve on the technology.

### SUMMARY OF THE INVENTION

This section provides a general summary of the disclosure, and is not a comprehensive disclosure of its full scope or its entire feature.

In one preferred embodiment, an apparatus for measuring formation resistivity in logging while drilling application includes a tool body, a pair of receivers deployed on the tool body including a first receiver and a second receiver, a measuring transmitter deployed on the tool body and at an axial distance from the pair of receivers, and a compensating transmitter deployed on the tool body and positioned substantially at the midpoint of the pair of receivers. The compensating transmitter transmits compensating signals to the pair of receivers and the measuring transmitter transmits measuring signals to the pair of receivers. The pair of receivers measures the amplitudes and phases of the compensating signals and the measuring signals in a sequential order and computes a compensated amplitude ratio and a compensated differential phase accordingly.

In some embodiments, the apparatus further includes a compensation controller coupled to the compensating transmitter and the pair of receivers\to determine receiver-induced error factors in amplitude and phase reflected in the pair of receivers when the compensating transmitter transmits compensating signals to the pair of receivers for calibrating receiver-induced error in amplitude and phase reflected in the pair of receivers when the measuring transmitter transmits measuring signals to the pair of receivers.

In other embodiments, the measuring transmitter comprises a measuring transmitter circuit configured to generate measuring signals to be transmitted by the measuring transmitter.

In other embodiments, the first receiver comprises a first receiver circuit configured to receive and process compensating and measuring signals.

In other embodiments, the second receiver comprises a second receiver circuit configured to receive and process compensating and measuring signals.

In other embodiments, the compensating transmitter comprises a compensating transmitter circuit configured to generate compensating signals to be transmitted by the compensating transmitter.

In other embodiments, the apparatus further includes a processor coupled to the compensating transmitter and the pair of receivers and configured to help determine receiver-induced error factors in amplitude and phase reflected in the pair of receivers when the compensating transmitter fires and to help the pair of receivers compute the compensated amplitude ratio and the compensated differential phase after the measuring transmitter firing.

In other embodiments, the apparatus further includes a storage device coupled to the processor and stored with a conversion chart, which is for converting the compensated amplitude ratio and the compensated differential phase into corresponding formation resistivity.

In another embodiment, the measuring transmitter is positioned near the first receiver and the corresponding compensated amplitude ratio is expressed by an equation

$${ρ}_{c} = \sqrt{\frac{{A}_{R 1}^{Tc}}{{A}_{R 2}^{Tc}} \cdot \frac{{A}_{R 2}^{Tm}}{{A}_{R 1}^{Tm}}}$$

where A_{R1}^{Tm} and A_{R2}^{Tm} represent the signal amplitudes of the measuring signals at the pair of receivers respectively when the measuring transmitter fires; where A_{R1}^{Tc} and A_{R2}^{Tc} represent the signal amplitudes of the compensating signals at the pair of receivers respectively when the compensating transmitter fires.

In another embodiment, the measuring transmitter is positioned near the second receiver and the corresponding compensated amplitude ratio is expressed by an equation

$${ρ}_{c} = \sqrt{\frac{{A}_{R 2}^{Tc}}{{A}_{R 1}^{Tc}} \cdot \frac{{A}_{R 1}^{Tm}}{{A}_{R 2}^{Tm}}}$$

where A_{R1}^{Tm} and A_{R2}^{Tm} represent the signal amplitudes of the measuring signals measured at the pair of receivers respectively when the measuring transmitter fires; where A_{R1}^{Tc} and A_{R2}^{Tc} represent the signal amplitudes of the compensating signals measured at the pair of receivers respectively when the compensating transmitter fires.

In another embodiment, the measuring transmitter is positioned near the first receiver and the corresponding compensated differential phase is expressed by an equation

$${Δφ}_{c} = \frac{( {φ}_{R 1}^{Tc} - {φ}_{R 2}^{Tc} ) + ( {φ}_{R 2}^{Tm} - {φ}_{R 1}^{Tm} )}{2}$$

where φ_{R1}^{Tm} and φ_{R2}^{Tm} represent the signal phase of the measuring signals measured at the pair of receivers respectively when the measuring transmitter fires; where φ_{R1}^{Tc} and φ_{R2}^{Tc} represent the signal phase of the compensating signals measured at the pair of receivers respectively when the compensating transmitter fires.

In another embodiment, the measuring transmitter is positioned near the second receiver and the corresponding compensated differential phase is expressed by an equation

$${Δφ}_{c} = \frac{( {φ}_{R 2}^{Tc} - {φ}_{R 1}^{Tc} ) + ( {φ}_{R 1}^{Tm} - {φ}_{R 2}^{Tm} )}{2}$$

where φ_{R1}^{Tm} and φ_{R2}^{Tm} represent the signal phase of the measuring signals measured at the pair of receivers respectively when the measuring transmitter fires; where φ_{R1}^{Tc} and φ_{R2}^{Tc} represent the signal phase of the compensating signals measured at the pair of receivers respectively when the compensating transmitter fires.

In another embodiment, each of the measuring transmitter, the compensating transmitter, and the pair of receivers further comprise at least one antenna for transmitting or receiving signals.

In still another embodiment, the tool body is a drilling collar.

In another preferred embodiment, a method for measuring formation resistivity in a subterranean borehole including deploying a tool body in the borehole; the tool body including a pair of receivers, a measuring transmitter at an axial distance from the pair of receivers, and a compensating transmitter substantially at the midpoint of the pair of receivers, firing the compensating transmitter to transmit compensating signals, utilizing the pair of receivers to receive the compensating signals from the compensating transmitter and measure the amplitudes and phases of the compensating signals, firing the measuring transmitter to transmit measuring signals, utilizing the pair of receivers to receive the measuring signals from the measuring transmitter and measure the amplitudes and phases of the measuring signals; and computing a compensated amplitude ratio and a compensated differential phase based on the amplitudes and phases of the compensating signals and the measuring signals.

In some embodiments, the method further includes providing a compensation controller coupled to the compensating transmitter and the pair of receivers to determine receiver-induced error factors in amplitude and phase reflected in the pair of receivers when the compensating transmitter is fired to reduce receiver-induced errors in amplitude and phase reflected in the pair of receivers when the measuring transmitter is fired.

In some embodiments, the method further includes providing a conversion chart to help convert the computed compensated amplitude ratio and the compensated differential phase into corresponding formation resistivity.

In still another preferred embodiment, a logging while drilling tool includes a drilling collar, a pair of receivers mounted on the drilling collar including a first receiver and a second receiver, multiple measuring transmitters mounted on the drilling collar, at an axial distance from the pair of receivers, and separated from each other, a compensating transmitter mounted on the drilling collar and positioned substantially at the midpoint of the pair of receivers, and a compensation controller coupled to the compensating transmitter to help calibrate receiver-induced errors in amplitude and phase reflected in the pair of receivers when the measuring transmitter transmits measuring signals to the pair of receivers by determining receiver-induced error factors in amplitude and phase reflected in the pair of receivers when the compensating transmitter transmits compensating signals to the pair of receivers.

The compensating transmitter transmits compensating signals to the pair of receivers and the measuring transmitters transmit measuring signals to the pair of receivers. The pair of receivers measures the amplitudes and phases of the compensating signals and the measuring signals in a sequential order and computes a compensated amplitude ratio and a compensated differential phase accordingly.

In some embodiments, each of the measuring transmitters, the compensating transmitter, and the pair of receivers further comprise at least one antenna for transmitting or receiving signals.

### BRIEF DESCRIPTION OF THE DRAWINGS

The drawings described herein are for illustrating purposes only of selected embodiments and not all possible implementation and are not intended to limit the scope of the present disclosure.

The detailed description will be better understood in conjunction with the accompanying drawings as follows:

FIG. 1 illustrates a prior art of a commonly used well logging device.

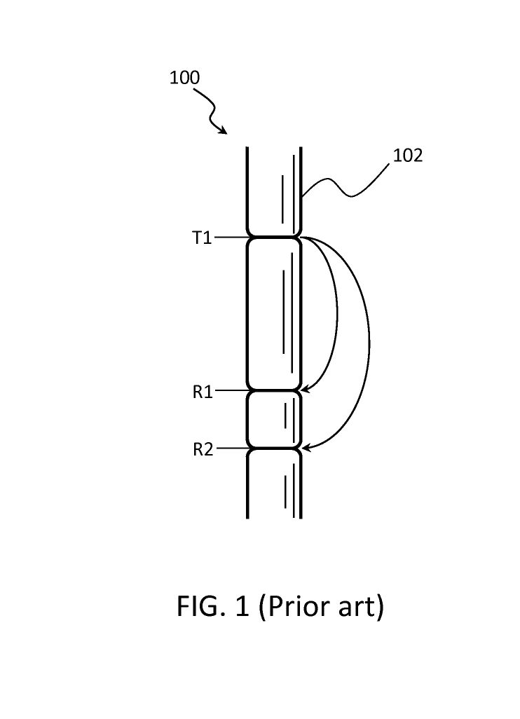

FIG. 2 illustrates a prior art of a compensated device with a pad which is deployed with a pair of transmitters and a pair of receivers.

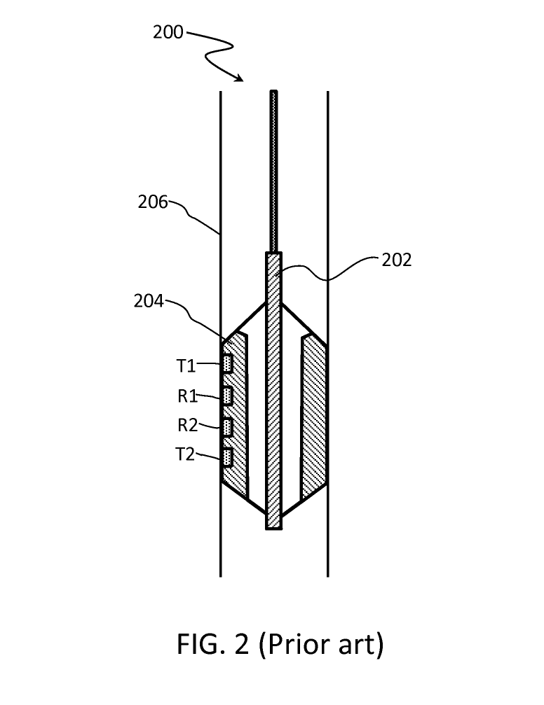

FIG. 3 illustrates a prior art of resistivity tool employing compensation mechanism.

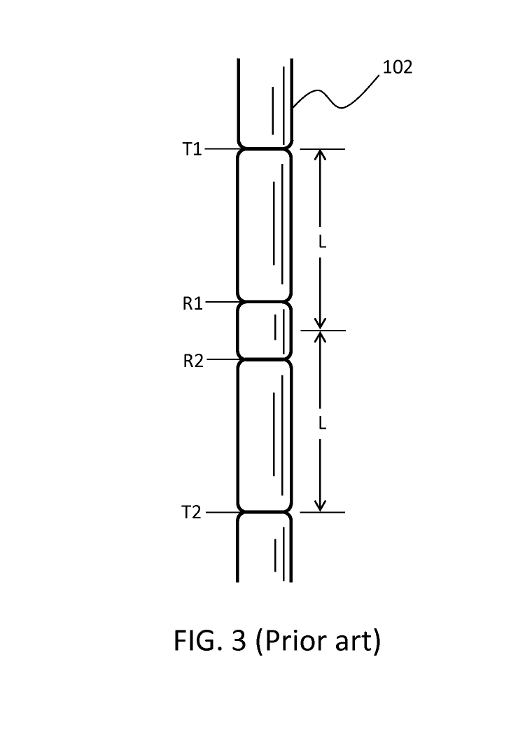

FIG. 4 illustrates another prior art of resistivity tool employing compensation mechanism.

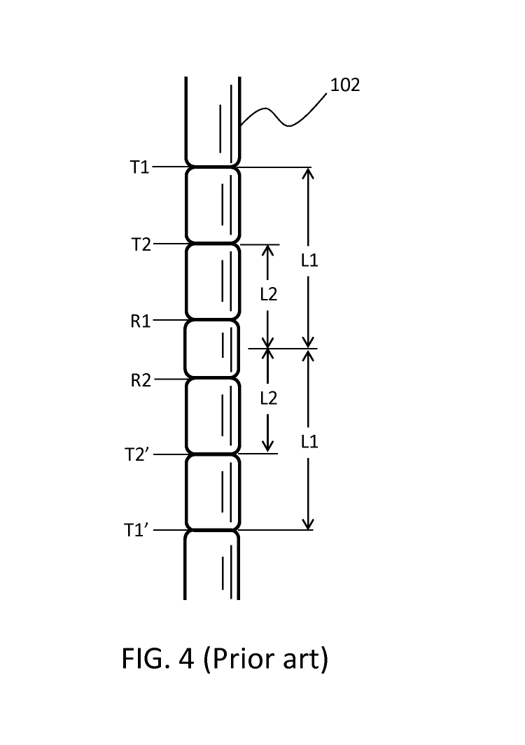

FIG. 5 illustrates another prior art of resistivity tool employing compensation mechanism.

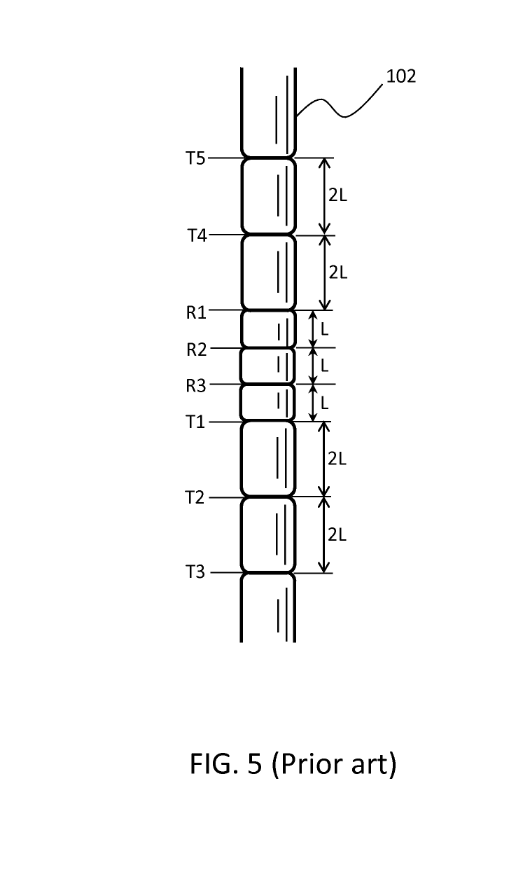

FIG. 6 illustrates a prior art of resistivity tool utilizing a pair of calibrating transmitters.

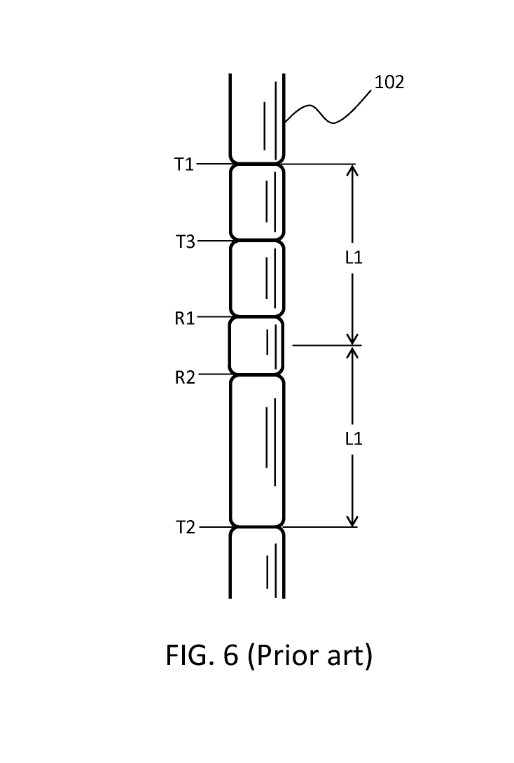

FIG. 7 illustrates a prior art of resistivity tool utilizing a pair of calibrating transmitters, which is located between a pair of receivers.

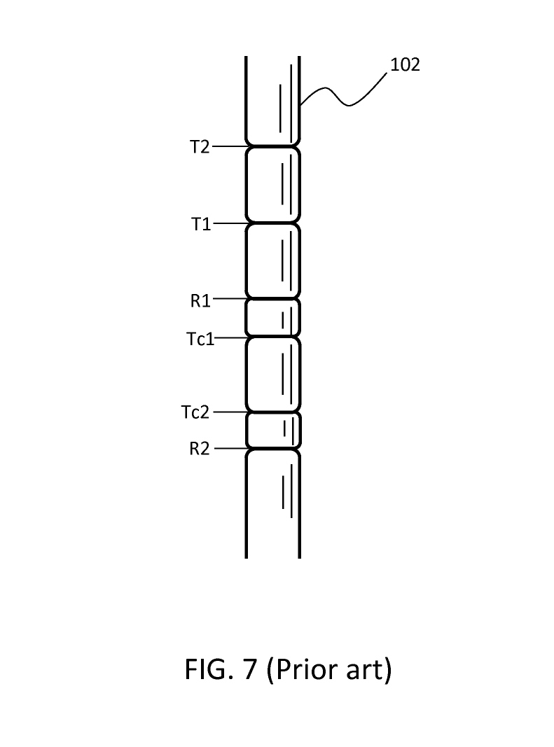

FIG. 8 illustrates a perspective view of a tool body deployed with a compensating transmitter, a pair of receivers, and measuring transmitters located on one side of the pair of receivers, for formation resistivity measurements according to some embodiments of the present invention.

FIG. 9 illustrates a perspective view of a tool body deployed with a compensating transmitter, a pair of receivers, and measuring transmitters located on both sides of the pair of receivers, for formation resistivity measurements according to some embodiments of the present invention.

FIG. 10 illustrates a schematic representation, partially in block diagram form, of an apparatus including a measuring transmitter, a compensating transmitter, and a pair of receivers coupled to a transmitter circuit, a first receiver circuit, a second receiver circuit, and a compensation controller for formation resistivity measurements according to some embodiments of the present invention.

FIG. 11 illustrates a flow chart of a method for measuring formation resistivity.

The present embodiments are detailed below with reference to the listed Figures.

### DETAILED DESCRIPTION OF THE EMBODIMENTS

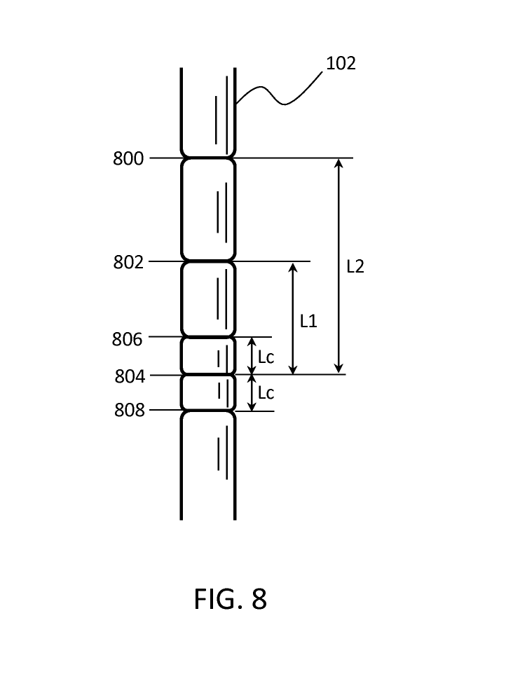

FIG. 8 illustrates a perspective view of a tool body 102 deployed with a compensating transmitter 804, a pair of receivers: a first receiver 806 and a second receiver 808, and measuring transmitters: a first measuring transmitter 802 and a second measuring transmitter 800, for formation resistivity measurements according to some embodiments of the present invention. The compensating transmitter 804 can be positioned substantially at the midpoint between the pair of receivers 806 and 808 (the distance from the compensating transmitter 804 to the pair of receivers 806 and 808 are both substantially equal to Lc). The first measuring transmitter 802 and the second measuring transmitter 800 can be positioned above the pair of receivers 806 and 808 at an axial distance (L1 & L2) from the midpoint of them. The need of multiple measuring transmitters (multiple offsets from the pair of receivers 806 and 808) is for conducting multiple depth investigation.

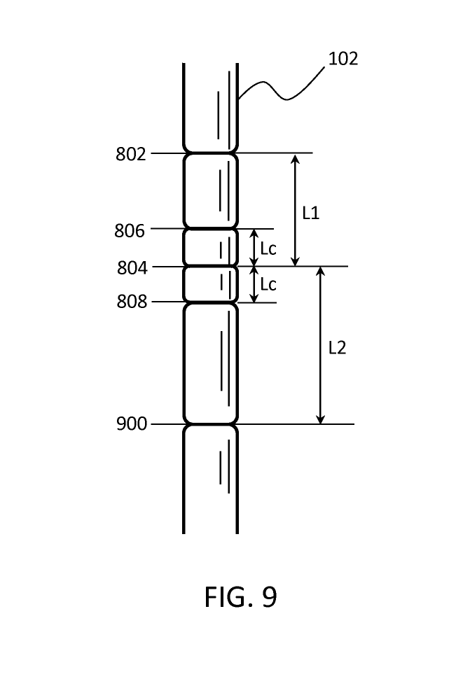

FIG. 9 illustrates another embodiment of the tool body 102 deployed with the compensating transmitter 804, the pair of receivers 806 and 808, the first measuring transmitter 802 located above the first receiver 806, and a third measuring transmitter 900 located below the second receiver 808, for formation resistivity measurements according to some embodiments of the present invention. One or more measuring transmitters can either be positioned above or below the pair of receivers 806 and 808 to make formation resistivity measurements.

In some embodiments, each of the measuring transmitters 800, 802, and 900, the compensating transmitter 804, and the pair of receivers 806 and 808 can further include at least one antenna for transmitting or receiving signals. The present invention is in no way limited to any particular shape, geometry, and number of such antenna(s).

In some embodiments, the tool body 102 can be a drilling collar.

In each measurement cycle, the compensating transmitter (“T_{c}”) 804 can be energized and transmit electromagnetic/compensating signals to the first receiver (“R₁”) 806 and the second receiver (“R₂”) 808 through surrounding formation first. The measured compensating signals at the receivers 806 and 808 when the compensating transmitter 804 fires can be expressed as follows.

Ã_{R1}^{Tc}=A_{R1}^{Tc}·e^{jφ}^{_{R1}}^{^{Tc}}=c_{Tc}^{err}·c_{R1(Tc)}^{err}·a_{R1}^{Tc}·e^{j(φ}^{_{R1}}^{^{Tc}}^{+φ}^{_{R1(Tc)}}^{^{err}}^{+φ}^{_{Tc}}^{^{err}}⁾ (19)

Ã_{R2}^{Tc}=A_{R2}^{Tc}·e^{jφ}^{_{R2}}^{^{Tc}}=c_{Tc}^{err}·c_{R2(Tc)}^{err}·a_{R2}^{Tc}·e^{j(φ}^{_{R2}}^{^{Tc}}^{+φ}^{_{R2(Tc)}}^{^{err}}^{+φ}^{_{Tc}}^{^{err}}⁾ (20)

where Ã_{R1}^{Tc} and Ã_{R2}^{Tc} are the measured compensating signals at the first receiver 806 and the second receiver 808 in complex format when the compensating transmitter 804 fires; where in Equations (19-20), the superscripts and subscripts represent the transmitter and receiver that are active when the signals are being measured; where the complex quantity Ã_{R1}^{Tc} is composed of measured compensating signal amplitude A_{R1}^{Tc} and measured compensating signal phase φ_{R1}^{Tc} at the first receiver 806 when the compensating transmitter Tc fires; where the complex quantity Ã_{R2}^{Tc} is composed of measured compensating signal amplitude A_{R2}^{Tc} and measured compensating signal phase φ_{R2}^{Tc} at the second receiver 808 when the compensating transmitter Tc fires; where a_{R1}^{Tc} and a_{R2}^{Tc} represent the formation related amplitude components of the measured compensating signals at the first receiver 806 and the second receiver 808 respectively when the compensating transmitter 804 fires; where φ_{R1}^{Tc} and φ_{R2}^{Tc} represent the formation related phase components of the measured compensating signals at the first receiver 806 and the second receiver 808 respectively when the compensating transmitter 804 fires; where c_{Tc}^{err} and φ_{Tc}^{err} are the compensating transmitter induced errors in amplitude and phase respectively on the pair of receivers 806 and 808 when the compensating transmitter 804 fires; where c_{R1(Tc)}^{err} and c_{R2(Tc)}^{err} are the receiver-induced errors in amplitude reflected in the pair of receivers 806 and 808 respectively when the compensating transmitter 804 fires; where φ_{R1(Tc)}^{err} and φ_{R2(Tc)}^{err} are the receiver-induced errors in phase reflected in the pair of receivers 806 and 808 respectively when the compensating transmitter 804 fires.

Due to the symmetrical arrangement of the compensating transmitter 804 and the pair of receivers 806 and 808, both the receiver-induced errors and the transmitter induced errors, which may be caused by embedded antennas or corresponding circuits, can be cancelled out from the measured amplitudes and measured phases. Accordingly, the results of compensated measurements between electromagnetic signal amplitudes and phases on the receivers 806 and 808 for formation resistivity computation can become more accurate because only the formation related amplitude and phase components would be left in the compensated amplitude ratios and compensated differential phases. Corresponding mathematical algorithm can be shown in Equations (21-25) below.

To make compensated measurements between the electromagnetic signal amplitudes and phases at the first receiver 806 and at the second receiver 808 for computing formation resistivity, first, the complex ratio of measured compensating signals at the first receiver 806 to the measured compensating signals at the second receiver 808 when the compensating transmitter 804 fires can be derived from Equations (19-20) as follows.

$${\tilde{ρ}}_{Tc} = \frac{{A}_{R 2}^{Tc} \cdot {e}^{j {φ}_{R 2}^{Tc}}}{{A}_{R 1}^{Tc} \cdot {e}^{j {φ}_{R 1}^{Tc}}} = \frac{{c}_{R 2 ( Tc )}^{err}}{{c}_{R 1 ( Tc )}^{err}} \cdot \frac{{a}_{R 2}^{Tc}}{{a}_{R 1}^{Tc}} \cdot {e}^{j ( {ϕ}_{R 2}^{Tc} - {ϕ}_{R 1}^{Tc} + {ϕ}_{R 2 ( Tc )}^{err} - {ϕ}_{R 1 ( Tc )}^{err} )} \qquad ( 21 )$$

where c_{Tc}^{err} and φ_{Tc}^{err}, the compensating transmitter induced errors in amplitude and phase respectively on the pair of receivers 806 and 808 when the compensating transmitter 804 fires, are cancelled in Equation (21).

In Equation (21), we can further assume a_{R2}^{Tc}=a_{R1}^{Tc} and φ_{R2}^{Tc}=φ_{R1}^{Tc} because 1) the spacing between the pair of receivers 806 and 808 are relatively small, e.g. 8 inches, and therefore the borehole shape and formation properties can be assumed homogeneous in this range in the propagation logging art; and 2) the compensating transmitter 804 is substantially located in the midpoint of the pair of receivers 806 and 808. Accordingly, the complex ratio for the compensating transmitter 804 firing becomes

$$\begin{matrix}{\tilde{ρ}}_{Tc} = \frac{{c}_{R 2 ( Tc )}^{err}}{{c}_{R 1 ( Tc )}^{err}} \cdot {e}^{j ( {ϕ}_{R 2 ( Tc )}^{err} - {ϕ}_{R 1 ( Tc )}^{err} )} \\ = {ρ}_{RX}^{err} \cdot {e}^{j Δ {φ}_{RX}^{err}}\end{matrix} \qquad ( 22 )$$

where

$${ρ}_{RX}^{err} = \frac{{c}_{R 2 ( Tc )}^{err}}{{c}_{R 1 ( Tc )}^{err}} and Δ {φ}_{RX}^{err} = {ϕ}_{R 2 ( Tc )}^{err} - {ϕ}_{R 1 ( Tc )}^{err}$$

are the receiver-induced error factors in amplitude ratio and phase shift reflected in the pair of receivers 806 and 808 respectively when the compensating transmitter 804 fires.

Alternatively, the complex ratio defined in Equation (22) can also be defined as follows.

$${\tilde{ρ}}_{Tc}^{′} = \frac{{\tilde{A}}_{R 1}^{Tc}}{{\tilde{A}}_{R 2}^{Tc}} = \frac{{c}_{R 1 ( Tc )}^{err}}{{c}_{R 2 ( Tc )}^{err}} \cdot {e}^{j ( {ϕ}_{R 1 ( Tc )}^{err} - {ϕ}_{R 2 ( Tc )}^{err} )} = \frac{1}{{ρ}_{RX}^{err} } \cdot {e}^{- j Δ {φ}_{RX}^{err}} \qquad ( 23 )$$

where ρ_{RX}^{err} and Δφ_{RX}^{err} share the same definition as in Equation (22). The two complex ratio definitions described in Equation (22) and Equation (23) are mathematically equivalent. Either Equation (22) or Equation (23) to be employed can depend on the location of the measuring transmitter relative to the receiver pair. Conventionally, the complex ratio is preferably defined as the signal of the farer receiver to the signal of the nearer receiver from the measuring transmitter.

Equations (22) and (23) show that after the compensating transmitter 804 firing, the differential phase between the compensating signal phases measured at the pair of receivers 806 and 808 represents the receiver-induced error factor in phase (Δφ_{RX}^{err}=φ_{R2(Tc)}^{err}−φ_{R1(Tc)}^{err} or Δφ_{RX}^{err}=φ_{R1(Tc)}^{err}−φ_{R2(Tc)}^{err}) reflected in the pair of receivers 806 and 808 and the amplitude ratio of the measured compensating signal amplitudes at the second receivers 808 to the measured compensating signal amplitudes at the first receivers 806 represents the receiver-induced error factor in amplitude

$$( {ρ}_{RX}^{err} = \frac{{c}_{R 2 ( Tc )}^{err}}{{c}_{R 1 ( Tc )}^{err}} or {ρ}_{RX}^{err} = \frac{{c}_{R 1 ( Tc )}^{err}}{{c}_{R 2 ( Tc )}^{err}} )$$

reflected in the pair of receivers 806 and 808.

After the compensating transmitter 804 firing, the measuring transmitter 802 is then energized and transmits electromagnetic signals/measuring signals to the pair of receivers 806 and 808 through surrounding formation. To make compensated measurements between the electromagnetic signal amplitudes and phases reflected at the first receiver 806 and at the second receiver8, secondly, the complex ratio for the measuring transmitter (“Tₘ”) 802 firing can be defined as follows.

$${\tilde{ρ}}_{Tm} = \frac{{\tilde{A}}_{R 2}^{Tm}}{{\tilde{A}}_{R 1}^{Tm}} = \frac{{A}_{R 2}^{Tm} {e}^{j {φ}_{R 2}^{Tm}}}{{A}_{R 1}^{Tm} {e}^{j {φ}_{R 1}^{Tm}}} = \frac{{c}_{R 2 ( Tm )}^{err}}{{c}_{R 1 ( Tm )}^{err}} \cdot \frac{{a}_{R 2}^{Tm}}{{a}_{R 1}^{Tm}} \cdot {e}^{j ( {ϕ}_{R 2}^{Tm} - {ϕ}_{R 1}^{Tm} + {ϕ}_{R 2 ( Tm )}^{err} - {ϕ}_{R 1 ( Tm )}^{err} )}$$

where Ã_{R1}^{Tm} and Ã_{R2}^{Tm} are the measured measuring signals at the first receiver 806 and the second receiver 808 in complex format when the measuring transmitter 802 fires; where in Equations (24), the superscripts and subscripts represent the transmitter and receiver that are active when the signals are being measured; where the complex quantity Ã_{R1}^{Tm} and Ã_{R2}^{Tm} are composed of measured amplitude A_{R1}^{Tm} and A_{R2}^{Tm} and measured phases φ_{R1}^{Tm} and φ_{R2}^{Tm}, respectively; where a_{R1}^{Tm} and a_{R2}^{Tm} represent the formation related amplitude components in the measured measuring signals at the first receiver 806 and the second receiver 808 respectively when the measuring transmitter8 fires; where φ_{R1}^{Tm} and φ_{R2}^{Tm} represent the formation related phase components in the measured measuring signals at the first receiver 806 and the second receiver8 respectively when the measuring transmitter 802 fires; c_{R1(Tm)}^{err} and c_{R2(Tm)}^{err} are receiver-induced errors in amplitude reflected in the pair of receivers 806 and 808 respectively when the measuring transmitter 802 fires; φ_{R1(Tm)}^{err} and φ_{R2(Tm)}^{err} are receiver-induced errors in phase reflected in the pair of receivers 806 and 808 respectively when the measuring transmitter 802 fires.

Finally, a compensated complex ratio can be derived by taking multiplication of \tilde{ρ}′_{Tc} in Equation (23) and \tilde{ρ}_{Tm} in Equation (24) as follows.

$${\tilde{ρ}}_{c} = {\tilde{ρ}}_{Tm} \cdot {\tilde{ρ}}_{Tc}^{′} = \frac{{\tilde{A}}_{R 2}^{Tm}}{{\tilde{A}}_{R 1}^{Tm}} \cdot \frac{{\tilde{A}}_{R 1}^{Tc}}{{\tilde{A}}_{R 2}^{Tc}} = \frac{{A}_{R 2}^{Tm} {e}^{j {φ}_{R 2}^{Tm}}}{{A}_{R 1}^{Tm} {e}^{j {φ}_{R 1}^{Tm}}} \cdot \frac{{A}_{R 1}^{Tc} {e}^{j {φ}_{R 1}^{Tc}}}{{A}_{R 2}^{Tc} {e}^{{jφ}_{R 2}^{Tc}}} = \frac{{a}_{R 2}^{Tm}}{{a}_{R 1}^{Tm}} \cdot {e}^{j ( {ϕ}_{R 2}^{Tm} - {ϕ}_{R 1}^{Tm} )} \qquad ( 25 )$$

After taking multiplication of \tilde{ρ}′_{Tc} and \tilde{ρ}_{Tm}, both the transmitter induced errors and the receiver-induced errors in amplitude and phase can be eliminated and only the formation related information (amplitude and phase components) are remained.

To reach the expression of Equation (25), assumptions have been taken that the receiver-induced errors in amplitude and phase when the compensating transmitter 804 fires are the same as the receiver-induced errors in amplitude and phase when the measuring transmitter 802 fires (c_{R1(Tc)}^{err}=c_{R1(Tm)}^{err}, c_{R2(Tc)}^{err}=c_{R2(Tm)}^{err}, φ_{R1(Tc)}^{err}=φ_{R1(Tm)}^{err}, and φ_{R1(Tc)}^{err}=φ_{R2(Tm)}^{err}), based on the property consistency of the receivers within a compensating transmitter and measuring transmitter firing cycle. It shows the importance of determination of the complex ratio \tilde{ρ}_{Tc} in Equation (22) or \tilde{ρ}′_{Tc} in Equation (23). To perform compensation operation between the compensating transmitter 804 and the measuring transmitter 802, the complex ratio \tilde{ρ}_{Tc} in Equation (22) or ρ′_{Tc}, in Equation (23) should be determined adequately to eliminate or reduce the receiver-induced errors in the measurement when the measuring transmitter 802 fires. If the complex ratio \tilde{ρ}_{Tc} or \tilde{ρ}′_{Tc} is wrongly determined, the receiver-induced errors in phase and amplitude reflected in the pair of receivers 806 and 808 when the measuring transmitter 802 fires would be doubled, instead of being eliminated or reduced.

In some embodiments, a compensation controller can be coupled to the compensating transmitter 804 and receivers 806 and 808 to help determine the receiver-induced errors in amplitude and phase reflected in the pair of receivers 806 and 808 when the compensating transmitter 804 fires.

The magnitude and phase of the compensated complex ratio \tilde{ρ}_{c} are called a compensated amplitude ratio and a compensated differential phase respectively for computing formation resistivity later. The compensated amplitude ratio and the compensated differential phase can be calculated using the measured signals at receivers 806 and 808 when the compensating transmitter 804 and the measuring transmitter 802 fire respectively and can be denoted as follows.

$$\begin{matrix}{ρ}_{c} = \sqrt{\frac{{A}_{R 2}^{Tm}}{{A}_{R 1}^{Tm}} \cdot \frac{{A}_{R 1}^{Tc}}{{A}_{R 2}^{Tc}}} & ( 26 ) \\ Δ {φ}_{c} = \frac{( {φ}_{R 2}^{Tm} - {φ}_{R 1}^{Tm} ) + ( {φ}_{R 1}^{Tc} - {φ}_{R 2}^{Tc} )}{2} & ( 27 )\end{matrix}$$

However, based on results of the mathematical deduction through Equations (21-25), only the formation related amplitude and phase components would be left in the compensated amplitude ratios and compensated differential phases as shown in Equations (26-27). Therefore, the final formation related amplitude ratio and differential phase can be shown as follows.

$$\begin{matrix}{ρ}_{c} = \sqrt{\frac{{a}_{ R 2}^{Tm}}{{a}_{R 1}^{Tm}} \cdot \frac{{a}_{R 1}^{Tc}}{{a}_{R 2}^{Tc}}} & ( 28 ) \\ Δ {φ}_{c} = ( {ϕ}_{R 2}^{Tm} - {ϕ}_{R 1}^{Tm} ) & ( 29 )\end{matrix}$$

Conventionally, the complex ratio is preferably defined as the signal of the farer receiver to the signal of the nearer receiver from the measuring transmitter. Therefore, if the measuring transmitter 802 is deployed axially below the second receiver 808, the compensated amplitude ratio and the compensated differential phase can be denoted as follows

$$\begin{matrix}{ρ}_{c} = \sqrt{\frac{{A}_{R 1}^{Tm}}{{A}_{R 2}^{Tm}} \cdot \frac{{A}_{R 2}^{Tc}}{{A}_{R 1}^{Tc}}} & ( 30 ) \\ Δ {φ}_{c} = \frac{( {φ}_{R 1}^{Tm} - {φ}_{R 2}^{Tm} ) + ( {φ}_{R 2}^{Tc} - {φ}_{R 1}^{Tc} )}{2} & ( 31 )\end{matrix}$$

Also based on results of the mathematical deduction through Equations (21-25), the final formation related amplitude ratio and differential phase can be shown as follows.

$$\begin{matrix}{ρ}_{c} = \sqrt{\frac{{a}_{R 1 }^{Tm}}{{a}_{R 2 }^{Tm}} \cdot \frac{{a}_{R 2}^{Tc}}{{a}_{R 1}^{Tc}}} & ( 32 ) \\ Δ {φ}_{c} = ( {ϕ}_{R 1}^{Tm} - {ϕ}_{R 2}^{Tm} ) & ( 33 )\end{matrix}$$

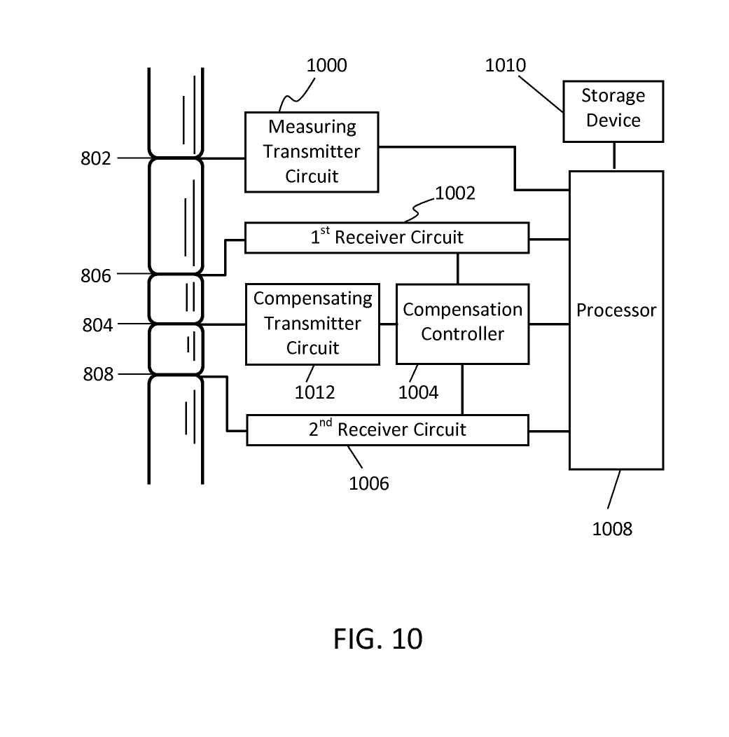

FIG. 10 illustrates a schematic representation, partially in block diagram form, of an apparatus including the first measuring transmitter 802, the compensating transmitter 804, and the pair of receivers 806 and 808 coupled to a measuring transmitter circuit 1000, a compensating transmitter circuit 1012, a first receiver circuit 1002, a second receiver circuit 1006, and a compensation controller 1004 for formation resistivity measurements according to some embodiments of the present invention. The measuring transmitter circuit 1000 can be coupled to the first measuring transmitter 802 and configured to generate measuring signals to be transmitted by the first measuring transmitter 802. The compensating transmitter circuit 1012 can be coupled to the compensating transmitter 804 and configured to generate compensating signals to be transmitted by the compensating transmitter 804. The compensating signals transmitted by the compensating transmitter 804 could be of lower strength than the measuring signals transmitted by the first measuring transmitter 802 due to the smaller propagation range of the compensating signal. The first receiver circuit 1002 can be coupled to the first receiver 806 and configured to receive and process the electromagnetic signals. The second receiver circuit 1006 can be coupled to the second receiver 808 and configured to receive and process the electromagnetic signals. The compensation controller 1004 can be coupled to the compensating transmitter circuit 1012, the first receiver circuit 1002, and the second receiver circuit 1006 and configured to adjust the strength of the compensating signals to be transmitted by the compensating transmitter 804 and to adequately determine the receiver-induced error factors in amplitude and phase reflected in the pair of receivers 806 and 808 when the compensating transmitter 804 fires, and to further eliminate the receiver-induced errors in amplitude and phase reflected in the pair of receiver 806 and 808 when the first measuring transmitter 802 fires later.

In some embodiments, a processor 1008 can be coupled to the measuring transmitter circuit 1000, the first receiver circuit 1002, the compensation controller 1004, and the second receiver circuit 1006 for helping the compensation controller 1004 to determine receiver-induced error factors in amplitude and phase in the pair of receivers 806 and 808 when the compensating transmitter 804 fires and for computing the compensated amplitude ratio and the compensated differential phase after the first measuring transmitter 802 firing.

In some embodiments, a storage device 1010 can be coupled to the processor 1008 and stored with a conversion chart, which is for converting the computed compensated amplitude ratio and compensated differential phase into corresponding formation resistivity.

In some embodiments, the processor 1008 can further compute the formation resistivity according to the conversion chart stored in the storage device 1010.

The present invention is in no way limited to the number of transmitter circuit 1000, especially when multiple measuring transmitters are applied.

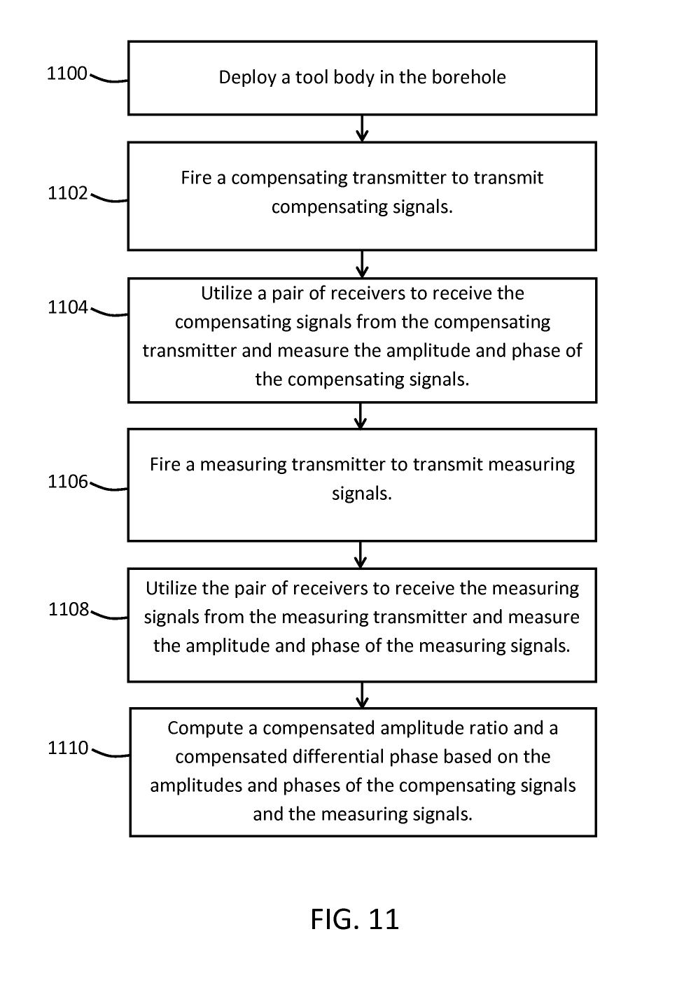

FIG. 11 illustrates a flow chart of a method for measuring formation resistivity. The method of measuring formation resistivity in a subterranean borehole includes deploying a tool body in the borehole 1100; the tool body including a pair of receivers, a measuring transmitter at an axial distance from the pair of receivers, and a compensating transmitter substantially at the midpoint of the pair of receivers, firing the compensating transmitter to transmit compensating signals 1102, utilizing the pair of receivers to receive the compensating signals from the compensating transmitter and measure the amplitude and phase of the compensating signals 1104, firing the measuring transmitter to transmit measuring signals 1106, utilizing the pair of receivers to receive the measuring signals from the measuring transmitter and measure the amplitude and phase of the measuring signals 1108, and computing a compensated amplitude ratio and a compensated differential phase based on the amplitudes and phases of the compensating signals and the measuring signals 1110.

In some embodiments, the method of measuring formation resistivity in a subterranean borehole further includes the step of providing a conversion chart to help convert the computed compensated amplitude ratio and compensated differential phase into corresponding formation resistivity.

In some embodiments, the method of measuring formation resistivity in a subterranean borehole further includes the step of providing a compensation controller coupled to the compensating transmitter and the pair of receivers to determine the receiver-induced errors in amplitude and phase reflected in the pair of receivers when the compensating transmitter is fired to reduce receiver-induced errors in amplitude and phase reflected in the pair of receivers when the measuring transmitter is fired.

However, the present invention is in no way limited to any particular order of steps or requires any particular step illustrated in FIG. 11.

In conclusion, exemplary embodiments of the present invention stated above may provide several advantages as follows. The present invention can utilize a compensating transmitter to eliminate the phase and amplitude errors induced by the pair of receivers when the measuring transmitter fires by determining phase and amplitude errors induced by the pair of receivers when the compensating transmitter fires. Furthermore, the compensating transmitter can be positioned between the pair of receivers and therefore the length of the logging tool can be shortened and the manufacturing costs can be decreased accordingly. Lastly, one compensating transmitter, instead of a pair of compensating transmitters, deployed between the pair of receivers could help reduce the risk of errors in amplitude and phase being induced because of a short distance between the receivers and the compensating transmitter.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An apparatus for measuring formation resistivity in logging while drilling application comprising:
a tool body;
a pair of receivers deployed on the tool body including a first receiver and a second receiver;
a measuring transmitter deployed on the tool body and at an axial distance from the pair of receivers;
a compensating transmitter deployed on the tool body and positioned substantially at the midpoint of the pair of receivers;
wherein the compensating transmitter transmits compensating signals to the pair of receivers and the measuring transmitter transmits measuring signals to the pair of receivers; and
wherein the pair of receivers measures the amplitudes and phases of the compensating signals and the measuring signals in a sequential order and computes a compensated amplitude ratio and a compensated differential phase accordingly.

2. The apparatus according to claim 1 further comprises a compensation controller coupled to the compensating transmitter and the pair of receivers to determine receiver-induced error factors in amplitude and phase reflected in the pair of receivers when the compensating transmitter transmits compensating signals to the pair of receivers for calibrating receiver-induced error in amplitude and phase reflected in the pair of receivers when the measuring transmitter transmits measuring signals to the pair of receivers.

3. The apparatus according to claim 2 further comprises a processor coupled to the compensation controller and the pair of receivers and configured to control the operation of the apparatus and help the compensation controller to determine receiver-induced error factors in amplitude and phase reflected in the pair of receivers when the compensating transmitter fires and to help the compensation controller compute the compensated amplitude ratio and the compensated differential phase after the measuring transmitter firing.

4. The apparatus according to claim 3 further comprises a storage device coupled to the processor and stored with a two-dimensional conversion chart, which is for converting the compensated amplitude ratio and the compensated differential phase into corresponding formation resistivity.

5. The apparatus according to claim 1 wherein the measuring transmitter comprises a measuring transmitter circuit configured to generate the measuring signals to be transmitted by the measuring transmitter.

6. The apparatus according to claim 1 wherein the first receiver comprises a first receiver circuit configured to receive and process the compensating and measuring signals transmitted by the compensating transmitter and measuring transmitter respectively.

7. The apparatus according to claim 1 wherein the second receiver comprises a second receiver circuit configured to receive and process the compensating and measuring signals transmitted by the compensating transmitter and measuring transmitter respectively.

8. The apparatus according to claim 1 wherein the compensating transmitter comprises a compensating transmitter circuit configured to generate compensating signals to be transmitted by the compensating transmitter.

9. The apparatus according to claim 1 wherein the measuring transmitter is positioned near the first receiver and the corresponding compensated amplitude ratio is expressed by an equation
$${ρ}_{c} = \sqrt{\frac{{a}_{R 1 }^{Tc}}{{a}_{R 2 }^{Tc}} \cdot \frac{{a}_{R 2}^{Tm}}{{a}_{R 1}^{Tm}}}$$
where A_{R1}^{Tm} and A_{R2}^{Tm} represent the signal amplitudes of the measuring signals measured at the pair of receivers respectively when the measuring transmitter fires; where A_{R1}^{Tc} and A_{R2}^{Tc} represent the signal amplitudes of the compensating signals measured at the pair of receivers respectively when the compensating transmitter fires.

10. The apparatus according to claim 1 wherein the measuring transmitter is positioned near the second receiver and the corresponding compensated amplitude ratio is expressed by an equation
$${ρ}_{c} = \sqrt{\frac{{A}_{R 2}^{Tc}}{{A}_{R 1}^{Tc}} \cdot \frac{{A}_{R 1}^{Tm}}{{A}_{R 2}^{Tm}}}$$
where A_{R1}^{Tm} and A_{R2}^{Tm} represent the signal amplitudes of the measuring signals measured at the pair of receivers respectively when the measuring transmitter fires; where A_{R1}^{Tc} and A_{R2}^{Tc} represent the signal amplitudes of the compensating signals measured at the pair of receivers respectively when the compensating transmitter fires.

11. The apparatus according to claim 1 wherein the measuring transmitter is positioned near the first receiver and the corresponding compensated differential phase is expressed by an equation
$$Δ {φ}_{c} = \frac{( {φ}_{R 1}^{Tc} - {φ}_{R 2}^{Tc} ) + ( {φ}_{R 2}^{Tm} - {φ}_{R 1}^{Tm} )}{2}$$
where φ_{R1}^{Tm} and φ_{R2}^{Tm} represent the signal phases of the measuring signals measured at the pair of receivers respectively when the measuring transmitter fires; where φ_{R1}^{Tc} and φ_{R2}^{Tc} represent the signal phases of the compensating signals measured at the pair of receivers respectively when the compensating transmitter fires.

12. The apparatus according to claim 1 wherein the measuring transmitter is positioned near the second receiver and the corresponding compensated differential phase is expressed by an equation
$$Δ {φ}_{c} = \frac{( {φ}_{R 2}^{Tc} - {φ}_{R 1}^{Tc} ) + ( {φ}_{R 1}^{Tm} - {φ}_{R 2}^{Tm} )}{2}$$
where φ_{R1}^{Tm} and φ_{R2}^{Tm} represent the signal phases of the measuring signals measured at the pair of receivers respectively when the measuring transmitter fires; where φ_{R1}^{Tc} and φ_{R2}^{Tc} represent the signal phases of the compensating signals measured at the pair of receivers respectively when the compensating transmitter fires.

13. The apparatus according to claim 1 wherein each of the measuring transmitter, the compensating transmitter, and the pair of receivers further comprise at least one antenna for transmitting or receiving signals.

14. The apparatus according to claim 1 wherein the tool body is a drilling collar.

15. A method for measuring formation resistivity in a subterranean borehole comprising:
deploying a tool body in the borehole; the tool body including a pair of receivers, a measuring transmitter at an axial distance from the pair of receivers, and a compensating transmitter substantially at the midpoint of the pair of receivers;
firing the compensating transmitter to transmit compensating signals;
utilizing the pair of receivers to receive the compensating signals from the compensating transmitter and measure the amplitudes and phases of the compensating signals;
firing the measuring transmitter to transmit measuring signals;
utilizing the pair of receivers to receive the measuring signals from the measuring transmitter and measure the amplitudes and phases of the measuring signals; and
computing a compensated amplitude ratio and a compensated differential phase based on the amplitudes and phases of the compensating signals and the measuring signals.

16. The method according to claim 15 further comprises providing a compensation controller coupled to the compensating transmitter and the pair of receivers to determine receiver-induced error factors in amplitude and phase reflected in the pair of receivers when the compensating transmitter is fired to reduce receiver-induced errors in amplitude and phase reflected in the pair of receivers when the measuring transmitter is fired.

17. The method according to claim 15 further comprises providing a conversion chart to help convert the computed compensated amplitude ratio and the compensated differential phase into corresponding formation resistivity.

18. A logging while drilling tool comprising:
a drilling collar;
a pair of receivers mounted on the drilling collar including a first receiver and a second receiver;
multiple measuring transmitters mounted on the drilling collar, at an axial distance from the pair of receivers, and separated from each other;
a compensating transmitter mounted on the drilling collar and positioned substantially at the midpoint of the pair of receivers;
wherein the compensating transmitter transmits compensating signals to the pair of receivers and the measuring transmitters transmit measuring signals to the pair of receivers; and
wherein the pair of receivers measures the amplitudes and phases of the compensating signals and the measuring signals in a sequential order and computes a compensated amplitude ratio and a compensated differential phase accordingly.

19. The apparatus according to claim 18 further comprises a compensation controller coupled to the compensating transmitter and the pair of receivers to help calibrate receiver-induced error in amplitude and phase reflected in the pair of receivers when the measuring transmitter transmits measuring signals to the pair of receivers by determining receiver-induced error factors in amplitude and phase reflected in the pair of receivers when the compensating transmitter transmits compensating signals to the pair of receivers.

20. The apparatus according to claim 19 further comprises a processor coupled to the compensation controller and the pair of receivers and configured to help the compensation controller to determine receiver-induced error factors in amplitude and phase reflected in the pair of receivers when the compensating transmitter fires and to help the pair of receivers compute the compensated amplitude ratio and the compensated differential phase after the measuring transmitter firing.

21. The apparatus according to claim 18 wherein each of the measuring transmitters, the compensating transmitter, and the pair of receivers further comprise at least one antenna for transmitting or receiving signals.
